(19) United States
(12) Patent Application Publication
(10) Pub. No.: US 2013/0092306 A1
(43) Pub. Date: Apr. 18, 2013

(54) Cap For A Valve Stem

(71) Applicant: Joseph F. White, Holland, MI (US)

(72) Inventor: Joseph F. White, Holland, MI (US)

(73) Assignee: BASF SE, Ludwigshafen, DE (DE)

(21) Appl. No.: 13/704,015

(22) PCT Filed: Jun. 16, 2010
(86) PCT No.: PCT/US2011/040689

§ 371 Date: Dec. 13, 2012

Related U.S. Application Data
(60) Provisional application No. 61/355,338, filed on Jun. 16, 2010.

(51) Int. Cl. B60C 29/06

(52) U.S. Cl. CPC B60C 29/06
USPC 152/429; 137/232

(57) ABSTRACT

A cap for a valve stem includes a housing extending along an axis from a first end to a second end. A bore extends along the axis from the first end toward the second end and a cup-shaped wall extends circumferentially about the bore for receiving the valve stem. A threaded surface is disposed in the bore for threadedly engaging the valve stem. A flange extends from the first end transversely to the axis and circumferentially around the bore for abutting the rim of the wheel to stabilize the housing relative to the rim of the wheel. Ribs are radially spaced about the housing and extend outwardly from the wall of the housing to the flange reinforcing the housing relative to the flange.

### BACKGROUND OF THE INVENTION

1. Field of the Invention

The present invention includes a cap for protecting a valve stem that extends through a rim of a wheel.

2. Description of the Related Art

With reference to prior art FIG. 2, a wheel includes a rim and a tire disposed about the rim. A valve stem extends from the tire, typically from a tube in the tire, through the rim so that the tire can be inflated and deflated through the valve stem. When used on heavy equipment, e.g., a heavy-duty vehicle, used in construction, earth moving, mining, etc., the valve stem tends to become gummed by dirt, dust, water, oil, grease, rocks, pebbles, etc. that collect on and in the valve stem. When the valve stem is gummed, it is difficult or impossible to properly inflate or deflate the tire through the valve stem.

In addition, rocks, dirt, etc. can collect between the valve stem and the rim and exert substantial forces on the valve stem. As a result, the rocks, dirt, etc., can bend and/or break the valve stem, which disadvantageously leads to pressure loss that can negatively influence the operation of the equipment and can cause expensive field repairs. In order to protect the valve stem from being bent and/or broken by the rocks, dirt, etc. wedged between the valve stem and the rim, one or more metal shields are welded onto the rim of the wheel to surround and protect the valve stem. The addition of this metal shield is very costly due to material costs associated with the metal shield and labor costs for cutting the metal shield and welding the metal shield to the rim. In addition, due to varying contours of the different rims and varying locations of valve stems on different rims, a different metal shield is designed and manufactured for each different type of rim to properly protect the valve stem on that particular type of rim. All of these factors increase the cost and time to manufacture the wheel.

In addition, some manufacturers of heavy-duty vehicles identify their products with a specific color. Accordingly, the valve stem and the metal shield are painted this color to match the rest of the heavy-duty vehicle. Again, the material costs and labor costs associated with painting increase the overall cost and time to manufacture the wheel. Accordingly, there remains an opportunity to increase the durability and reliability of the valve stem and to decrease the cost and time to manufacture the wheel.

### SUMMARY OF THE INVENTION AND ADVANTAGES

The present invention includes a cap for a valve stem extending from a tire through a rim of a wheel. The cap comprises a housing extending along an axis from a first end to a second end and having a bore extending along the axis from the first end toward the second end and a cup-shaped wall extending circumferentially about the bore for receiving the valve stem. A threaded surface is disposed in the bore for threadedly engaging the valve stem. A flange extends from the first end transversely to the axis and circumferentially around the bore for abutting the rim of the wheel to stabilize the housing relative to the rim of the wheel. Ribs are radially spaced about the housing and extend outwardly from the wall of the housing to the flange reinforcing the housing relative to the flange.

The present invention also includes a wheel for a vehicle. The wheel comprises a rim. A tire is disposed about the rim. A valve stem extends from the tire through the rim. A cap has a housing extending along an axis from a first end to a second end and has a bore extending along the axis from the first end toward the second end and a cup-shaped wall extending circumferentially about the bore receiving the valve stem. The cap has a threaded surface disposed in the bore threadedly engaging the valve stem. The cap has a flange extending from the first end transversely to the axis and circumferentially around the bore and abuts the rim of the wheel to stabilize the housing relative to the rim. The cap has ribs radially spaced about the housing and extending outwardly from the wall of the housing to the flange reinforcing the housing relative to the flange.

The cap not only protects the valve stem from materials that can gum the valve stem such as dirt, dust, water, oil, grease, rocks, pebbles, etc., but also protects the valve stem from rocks and dirt that can become wedged between the rim and the cap and exert lateral forces on the cap. Specifically, the flange widens the footprint of the cap to reduce the likelihood that the cap is rolled on the rim due to lateral forces on the cap, e.g., by rocks and dirt wedged between the rim and the cap. The flange also increases the area of contact between the cap and the rim. When the cap is threadedly engaged with the valve stem, the area of contact between the cap and the rim of the wheel assures that the cap is firmly seated against the rim to prevent rolling of the cap on the rim due to lateral forces on the cap.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a heavy-duty vehicle;

FIG. 2 is perspective view of a portion of a wheel having a prior art metal shield welded on a rim of a wheel;

FIG. 3 is a partially exploded view of a portion of a wheel including a cap and a valve stem;

FIG. 4 is a perspective view of the cap;

FIG. 5 is another perspective view of the cap including a nut engaged in a bore of the cap;

FIG. 6 is a top view of the cap;

FIG. 7 is a partial cross-sectional view of the cap engaged with the valve stem along line 7-7 of FIG. 1;

FIG. 8 is a perspective view of another embodiment of the cap including threads defined in the bore of the cap;

FIG. 9 is a partial cross-sectional view of another embodiment of the cap engaged with the valve stem; and

FIG. 10 is a perspective view of the embodiment of the cap shown in FIG. 8.

### DETAILED DESCRIPTION OF THE INVENTION

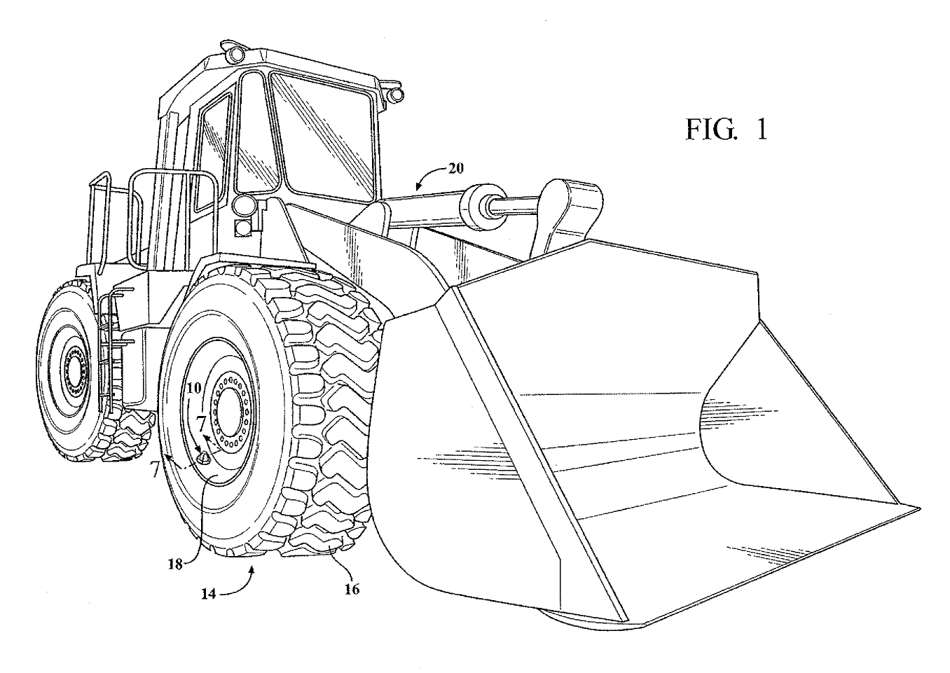

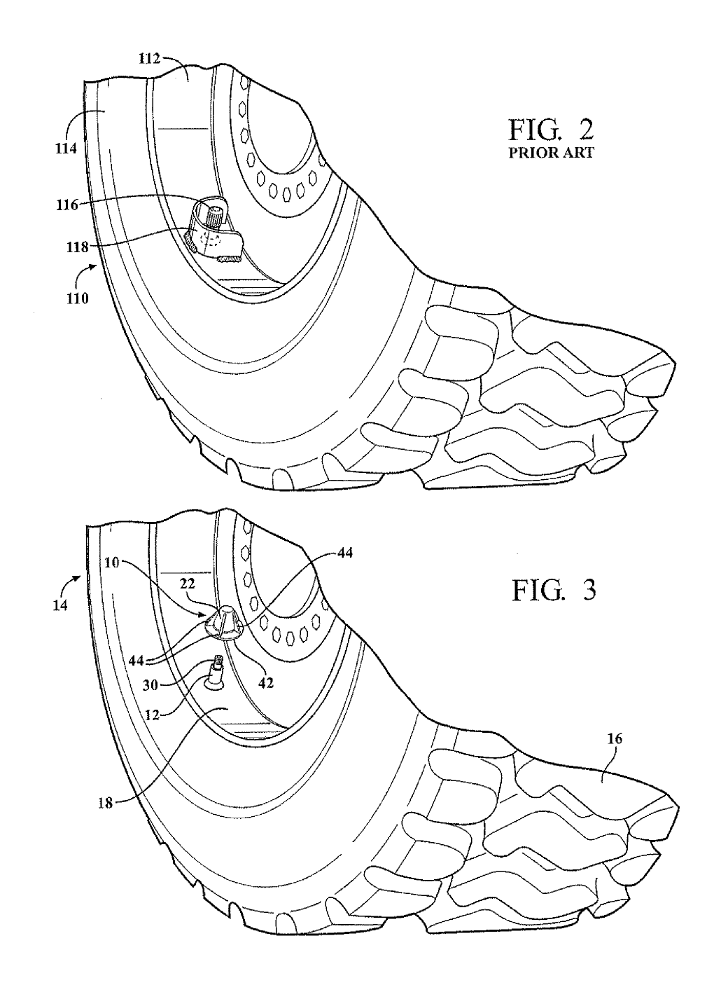

Referring to the Figures, wherein like numerals indicate like parts throughout the several views, a cap for a valve stem 12 is generally shown at 10. As best shown in FIG. 3, the cap 10 and the valve stem 12 are disposed on a wheel 14. The valve stem 12 extends from a tire 16 through a rim 18 of the wheel 14. With reference to FIG. 1, the wheel 14 can, for example, be disposed on heavy equipment 20, e.g., a heavy-duty vehicle, used in construction, earth moving, mining, etc. In such applications, the cap 10 protects the valve stem 12 from rocks, dirt, etc., that can become wedged between the valve stem 12 and the rim 18 and could otherwise damage the valve stem 12. Specifically, such materials can exert significant forces on the valve stem 12 in the absence of the cap 10 and the cap 10 supports the valve stem 12 to prevent such forces from bending and/or breaking the valve stem 12. However, it should be appreciated that the cap 10 can be used on any type of wheel on any type of machine without departing from the nature of the present invention.

The valve stem 12 includes a valve (not shown) that can be opened to inflate and deflate the tire 16 and can be closed to maintain the inflation of the tire 16. Typically, for example, the tire 16 includes a tube (not shown) connected to the valve stem 12 and extending around the rim 18 for inflation and deflation. The valve stem 12 can be, for example, of the types commonly referred to as Schader valves, Presta valves, or Dunlop valves. However, it should be appreciated that the valve stem 12 can be of any type without departing from the nature of the present invention.

The cap 10 is disposed over the valve stem 12, as shown in FIG. 1, to protect the valve stem 12 from materials such as dirt, dust, water, oil, grease, rocks, pebbles, etc. from collecting on and in the valve stem 12 and preventing proper inflation and deflation. Specifically, the valve stem 12 typically includes a reed (not shown) disposed in the valve stem 12 and being moveable to inflate or deflate the tire 16. The cap 10 prevents materials from being lodged in the valve stem 12 and interfering with the proper function of the reed.

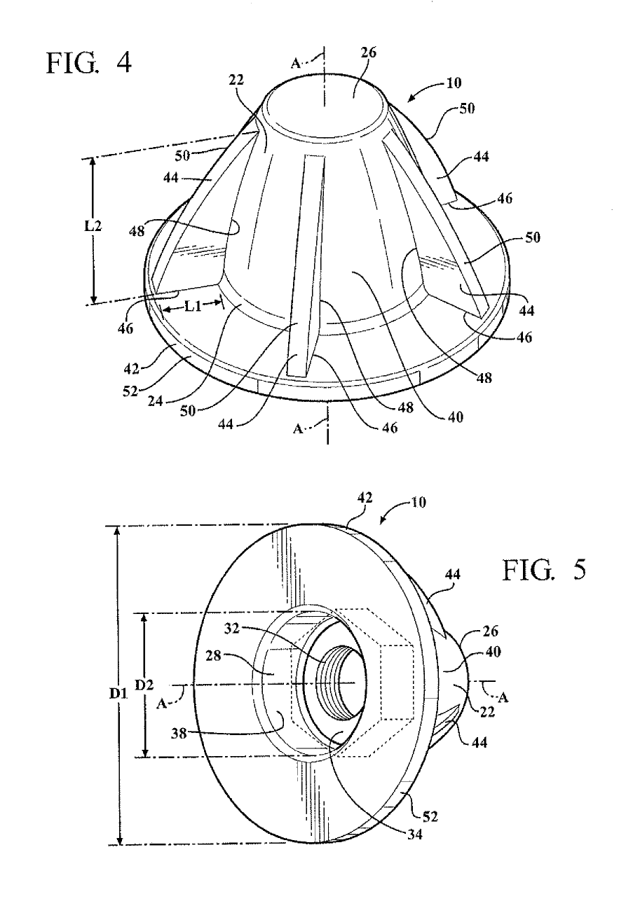

With reference to FIG. 4, the cap 10 includes a housing 22 extending along an axis A from a first end 24 to a second end 26. The cap 10 has a bore 28 extending into the housing 22 along the axis A from the first end 24 toward the second end 26. As shown in FIG. 3, the cap 10 receives the valve stem 12 in the bore 28 to enclose the valve stem 12 between the housing 22 and the rim 18 of the wheel 14.

As best shown in FIG. 3, the valve stem 12 presents a threaded shaft 30. With reference to FIGS. 5 and 7-9, a threaded surface 32 is disposed in the bore 28 for threadedly engaging the threaded shaft 30 of the valve stem 12. As one example shown in FIG. 5, a nut 34 is fixed to the housing 22 in the bore 28 and presents the threaded surface 32. The nut 34 can be held in the bore 28 by ridges 36, as best shown in FIG. 7. For example, the ridges 36 can be formed by overmolding the housing 22 onto the nut 34. Typically, the overmolding is performed by plastic injection molding the housing 22 around the nut 34. Alternatively, the nut 34 can be press fit into engagement with an inner surface 38 of the housing 22. Alternatively, for example as shown in FIG. 8, the inner surface 38 of the housing 22 can define the threaded surface 32. In such a scenario, the threaded surface 32 can be, for example, formed by injection molding.

With reference to FIGS. 4-7, the housing 22 includes a cup-shaped wall 40 extending circumferentially about the bore 28 for receiving the valve stem 12, i.e., the valve stem 12 is received by the bore 28 and surrounded by the cup-shaped wall 40. The wall 40 is cup-shaped in that it typically tapers inwardly toward the axis A from the first end 24 to the second end 26 to cup the valve stem 12 when the cap 10 is threadedly engaged with the valve stem 12. The first end 24 and the second end 26 of the housing 22 are typically cylindrical. It should be appreciated that the housing 22 can be of any shape without departing from the nature of the present invention.

A flange 42 extends from the first end 24 for abutting the rim 18 of the wheel 14 to stabilize the housing 22 relative to the rim 18 of the wheel 14. In other words, as shown in FIG. 7, the flange 42 abuts the rim 18 when the cap 10 is threadedly engaged with the valve stem 12. The flange 42 extends transversely to the axis A and circumferentially around the bore 28, i.e., flares outwardly relative to the bore 28. The flange 42 is typically cylindrical but can be of any shape without departing from the nature of the present invention.

The flange 42 widens the footprint of the cap 10 to reduce the likelihood that the cap 10 is rolled on the rim 18 due to lateral forces on the cap 10, e.g., by rocks and dirt wedged between the rim 18 and the cap 10. Specifically, the housing 22 defines a height H from the first end 24 to the second end 26 and the flange 42 has an outer diameter D1 greater than the height H. In other words, the flange 42 is wider than the housing 22 is tall to lower the center of gravity of the cap 10.

The flange 42 also increases the area of contact between the cap 10 and the rim 18. Specifically, the bore 28 has a diameter D2 and the outer diameter D1 of the flange 42 is at least twice the size of the bore diameter D2 so that the flange 42 is capable of firmly seating against the rim 18. When the cap 10 is threaded onto the valve stem 12 so that the flange 42 contacts the rim 18, the increased area of contact between the cap 10 and the rim 18 of the wheel 14 assures that the cap 10 is firmly seated against the rim 18 to prevent rolling of the cap 10 on the rim 18 due to lateral forces on the cap 10.

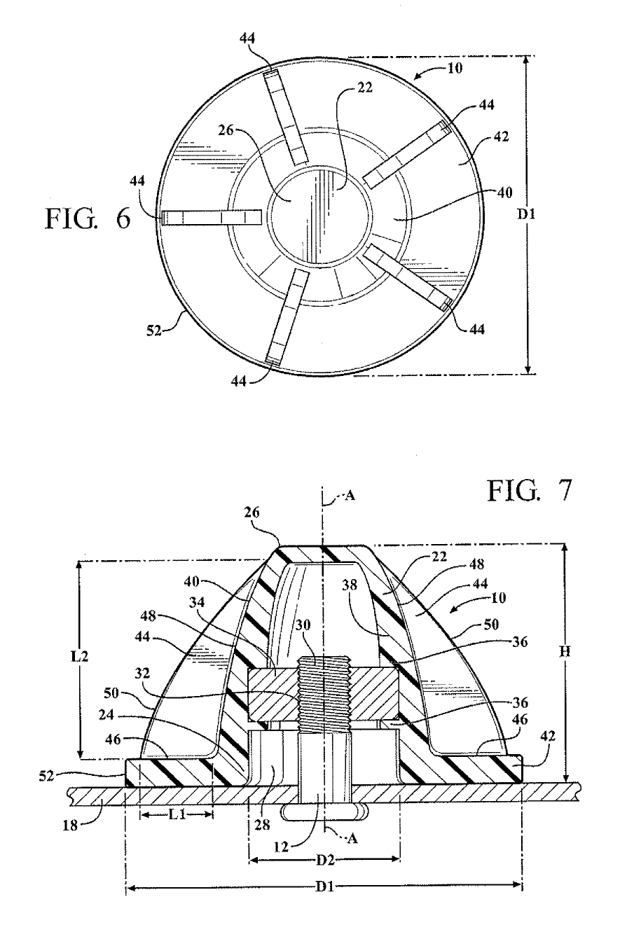

Ribs 44 are radially spaced about the housing 22. The ribs 44 extend outwardly from the wall 40 of the housing 22 to the flange 42 reinforcing the housing 22 relative to the flange 42. In other words, the ribs 44 strengthen the relative stability of the flange 42 and the housing 22 to limit the bending of the housing 22 relative to the flange 42. As best shown in FIG. 6, the cap 10 typically includes five ribs 44 spaced equidistantly about the housing 22. However, it should be appreciated that the cap 10 can include any number of ribs 44 without departing from the nature of the present invention.

Each rib 44 has three sides defining a generally triangular shape. Specifically, a first side 46 is typically integral with and extends along the flange 42 outwardly relative to the axis A. A second side 48 is typically integral with and extends along the wall 40 generally along the axis A. A third side 50 extends from the first side 46 to the second side 48. The term “integral” is used herein to mean formed of a single part such as by molding, casting, machining from a single piece of material, etc. As an alternative to the first side 46 being integral with the flange 42 and the second side 48 being integral with the wall 40, the rib 44 could be separately formed and subsequently attached to the flange 42 and the housing 22 by, for example, adhering, melt bonding, fusing, welding, etc.

The ribs 44 extend almost the entire 16 height H of the housing 22 from the first end 24 almost entirely to the second end 26. The ribs 44 also extend almost the entire 16 width of the flange 42 from the wall 40 almost entirely to an outer edge 52 of the flange 42. Specifically, the first side 46 of the rib 44 extends a first length L1 along the flange 42 and the second side 48 of the rib 44 extends a second length L2 along the wall 40. The first length L1 is at least one third as along as the second length L2. As such, the ribs 44 can be grasped by hand or by tool to loosen or tighten the cap 10 on the valve stem 12.

The housing 22, the flange 42, and the ribs 44 are typically integrally formed, i.e., formed as a single part, of glass filled nylon. The nylon is typically impact modified with a good low temperature and high temperature impact resistance. The nylon is typically injection molding grade so that the cap 10 can be formed by injection molding. The nylon is also easily colored, for example, to match the color of the rim 18. One example of a suitable nylon is that commercially available from BASF Corporation in Florham Park, N.J. under the tradename Ultramid® A3Z. However, it should be appreciated that the cap 10 can be formed of any type of suitable material without departing from the nature of the present invention.

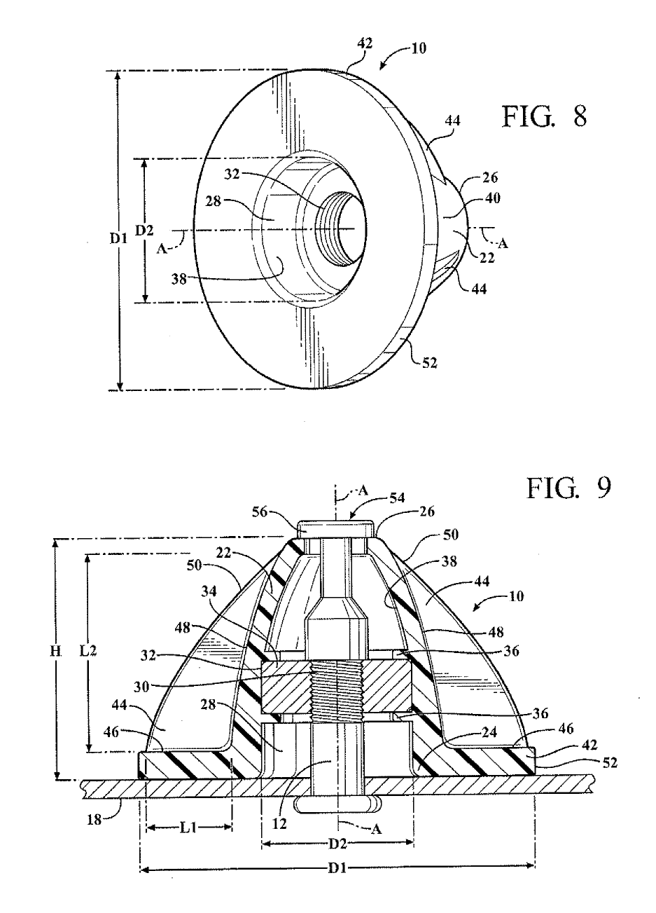

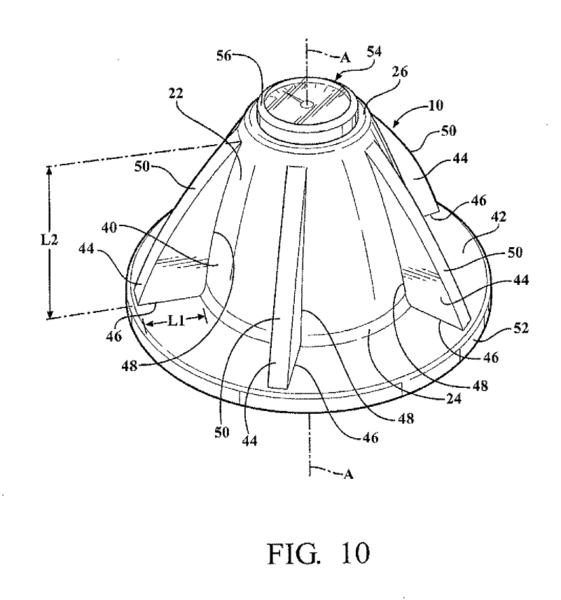

With reference to FIGS. 9 and 10, the cap 10 can include a pressure gauge 54 extending into the bore 28 for engaging the valve stem 12. The pressure gauge 54 typically extends through the second end 26 of the housing 22 and typically threadedly engages the threaded shaft 30. When the cap 10 is threaded onto the threaded shaft 30, the pressure gauge 54 is typically in constant engagement with the valve stem 12 so that the pressure gauge 54 is typically constantly measuring the pressure of the tire 16. In other words, the pressure gauge 54 engages the valve stem 12 when the cap 10 is rotated onto the threaded shaft 30 and disengages the valve stem 12 when the cap 10 is rotated off the threaded shaft 30.

The pressure gauge 54 includes an indicator 56 that typically abuts the second end 26 of the housing 22. The indicator 56 faces outwardly from the housing 22 for indicating the inflation pressure of the tire 16. For example, the indicator 56 can include light emitting diodes (LED) (not shown) that indicate the inflation pressure of the tire 16. For example, the indicator 56 can include a green colored LED that is lit when the inflation pressure is acceptable and a red colored LED that is lit when the inflation pressure is unacceptable. Alternatively, the indicator 56 can include a number of LEDs each indicating a range of inflation pressure. Alternatively or in addition to the LEDs, the indicator 56 can include an analog dial or a digital reading indicating the inflation pressure. In the alternative or in addition to one or more LEDs, the pressure gauge 54 can be in communication with an interior of the heavy equipment 20 to indicate tire pressure of the wheel 14. For example, the pressure gauge 54 can be in communication with an instrument panel (not shown) in the interior of the heavy equipment 20.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

1. A cap for a valve stem extending from a tire through a rim of a wheel, said cap comprising:
a housing extending along an axis from a first end to a second end and having a bore extending along said axis from said first end toward said second end and a cup-shaped wall extending circumferentially about said bore for receiving the valve stem;
a threaded surface disposed in said bore for threadedly engaging the valve stem;
a flange extending from said first end transversely to said axis and circumferentially around said bore for abutting the rim of the wheel to stabilize said housing relative to the rim of the wheel; and
ribs radially spaced about said housing and extending outwardly from said wall of said housing to said flange reinforcing said housing relative to said flange.

2. The cap as set forth in claim 1 wherein said housing defines a height from said first end to said second end and wherein said flange has an outer diameter greater than said height.

3. The cap as set forth in claim 2 wherein said bore has a diameter and wherein said outer diameter of said flange is at least twice the size of said bore diameter so that said flange is capable of firmly seating against the rim.

4. The cap as set forth in claim 1 wherein each of said ribs have three sides defining a generally triangular shape with a first side integral with and extending along said flange outwardly relative to said axis, with a second side integral with and extending along said wall generally along said axis, and with a third side extending from said first side to said second side.

5. The cap as set forth in claim 4 wherein said first side of said rib extends a first length along said flange and said second side of said rib extends a second length along said wall and wherein said first length is at least one third as along as said second length.

6. The cap as set forth in claim 1 wherein said housing tapers inwardly toward said axis from said first end to said second end.

7. The cap as set forth in claim 1 wherein said flange is cylindrical.

8. The cap as set forth in claim 1 further comprising a nut fixed to said housing in said bore and presenting said threaded surface.

9. The cap as set forth in claim 1 wherein said housing, said flange, and said ribs are integrally formed of glass filled nylon.

10. The cap as set forth in claim 1 further comprising a pressure gauge extending into said bore for engaging the valve stem and having an indicator facing outwardly from said housing for indicating the inflation pressure of the tire.

11. The cap as set forth in claim 10 wherein said pressure gauge extends through said second end of said housing and said indicator abuts said second end of said housing.

12. A cap for a valve stem extending from a tire through a rim of a wheel, said cap comprising:
a housing extending along an axis from a first end to a second end and having a bore extending along said axis from said first end toward said second end and a cup-shaped wall extending circumferentially about said bore for receiving the valve stem;
a threaded surface disposed in said bore for threadedly engaging the valve stem;
a flange extending from said first end transversely to said axis and circumferentially around said bore for abutting the rim of the wheel to stabilize said housing relative to the rim of the wheel;
said housing defining a height from said first end to said second end and said flange having an outer diameter greater than said height;
said bore having a diameter and said outer diameter of said flange being at least twice the size of said bore diameter so that said flange is capable of firmly seating against the rim;
ribs radially spaced about said housing and extending outwardly from said wall of said housing to said flange reinforcing said housing relative to said flange;
each of said ribs having three sides defining a generally triangular shape with a first side integral with and extending along said flange outwardly relative to said axis, with a second side integral with and extending along said wall generally along said axis, and with a third side extending from said first side to said second side;
said first side of said rib extending a first length along said flange and said second side of said rib extending a second length along said wall, said first length is at least one third as along as said second length; and
said housing, said flange, and said ribs being integrally formed of glass filled nylon.

13. The cap as set forth in claim 12 wherein said flange is cylindrical and wherein said housing tapers inwardly toward said axis from said first end to said second end.

14. The cap as set forth in claim 13 further comprising a nut fixed to said housing in said bore and presenting said threaded surface.

15. A wheel for a vehicle, said wheel comprising:
a rim;
a tire disposed about said rim;
a valve stem extending from said tire through said rim; and
a cap having a housing extending along an axis from a first end to a second end and having a bore extending along said axis from said first end toward said second end and a cup-shaped wall extending circumferentially about said bore receiving said valve stem;
said cap having a threaded surface disposed in said bore threadedly engaging said valve stem;
said cap having a flange extending from said first end transversely to said axis and circumferentially around said bore and abutting said rim of said wheel to stabilize said housing relative to said rim; and
said cap having ribs radially spaced about said housing and extending outwardly from said wall of said housing to said flange reinforcing said housing relative to said flange.

16. The cap as set forth in claim 15 wherein said housing defines a height from said first end to said second end and wherein said flange has an outer diameter greater than said height.

17. The cap as set forth in claim 16 wherein said bore has a diameter and wherein said outer diameter of said flange is at least twice the size of said bore diameter so that said flange is capable of firmly seating against the rim.

18. The cap as set forth in claim 15 wherein each of said ribs have three sides defining a generally triangular shape with a first side integral with and extending along said flange outwardly relative to said axis, with a second side integral with and extending along said wall generally along said axis, and with a third side extending from said first side to said second side.

19. The cap as set forth in claim 18 wherein said first side of said rib extends a first length along said flange and said second side of said rib extends a second length along said wall and wherein said first length is at least one third as along as said second length.
